(19) United States
(12) Patent Application Publication
(10) Pub. No.: US 2010/0309160 A1
(43) Pub. Date: Dec. 9, 2010

(54) CAPACITIVE SENSING ASSEMBLY OF TOUCH PANEL

(76) Inventor: Teh-Zheng Lin, Taoyuan (TW)

Correspondence Address: Teh-Zheng Lin, 235 Chung - Ho Box 8-24, Taipei, 235, TW

(21) Appl. No.: 12/481,568

(22) Filed: Jun. 9, 2009

(51) Int. Cl. G06F 3/045

(52) U.S. Cl. 345/174

(57) ABSTRACT

A capacitive sensing assembly of a touch panel comprises a plurality of transparent X axis traces having a plurality of X axis sensing units; a plurality of transparent Y axis traces having a plurality of connected Y axis sensing units. The Y axis traces are alternatively arranged with the X axis traces so that the X axis sensing units and Y axis sensing units are arranged as a matrix at a working area of a touch panel. Gaps between the X axis traces and Y axis traces are arranged with dummy patterns. Furthermore, a capacitive sensing assembly of a touch panel is provided, which includes a lower substrate; an upper panel; a capacitive sensing layer installed connected the lower substrate and the upper panel. In a working area of a touch panel, the capacitive sensing layer having a plurality of sensing units which are arranged alternatively and gaps between the sensing units are filled with dummy patterns.

### FIELD OF THE INVENTION

The present invention relates a touch panel, in particular to a capacitive sensing assembly of a touch panel which can reduce the capacitance of noise and has uniform transmittance distribution.

### BACKGROUND OF THE INVENTION

A capacitive touch panel can generate a capacitive effect by a finger to touch a screen of a panel. The variation of capacitance will indicate the position of the finger. Thereby, the object of transmitting signals is achieved. Since the signal input of a capacitive touch panel is performed through fingers, the operation is convenient. No pressure is necessary in input operation and panel will not suffer from the defects of stress and deformation. The structure is simple and less elements are used, while the yield ratio is high. Mass product can be performed with less cost. Thus it is widely used in communication, computer and other electronic products. The prior art capacitive sensing structure has a plurality of X axis traces and a plurality of Y axis traces. The X axis trace has a plurality of X axis sensing units and the Y axis trace has a plurality of Y axis sensing units. The X axis traces and Y axis traces are arranged alternatively and are insulated from each other. The sensing units of the X axis traces and Y axis traces are arranged as a matrix on a working area of the touch panel. Generally, the X axis trace and Y axis trace are made as transparent thin film, such as Indium Tin Oxide (ITO) material. In manufacturing, undesired part is etched out for forming each sensing unit so that the sensing units of the X axis traces and Y axis traces are spaced with proper gaps to have the object of insulation. If the gap is too small, EMI (electromagnetic interference) or capacitive interference will occur so that the sensitivity and preciseness of the capacitive sensing signals will reduce. If the gap is increased, the transmittances for the part with capacitive sensing units and the part without capacitive sensing units are different so that the light refraction on the panel is not uniform. As a result, the images on the screen will distort and deform.

### SUMMARY OF THE INVENTION

Accordingly, the object of the present invention is to provide a capacitive sensing assembly for a touch panel. Dummy patterns are filled between the capacitive sensing units. The dummy patterns and capacitive sensing units have identical transmittance or the transmittance thereof have a difference below 6% so that the gaps between the sensing units are reduced greatly. Thereby, the flatness of the capacitive sensing assembly is increased and the transmittance is more uniformly in the screen surface. The distortion at the display below the touch panel is improved. The gap become the capacitive sensing units is enlarged for reducing the capacitance of the noise.

To achieve above object, the present invention provide a capacitive sensing assembly of a touch panel comprising: a plurality of transparent X axis traces; each X axis trace having a plurality of connected X axis sensing units; a plurality of transparent Y axis traces; each Y axis trace having a plurality of connected Y axis sensing units; wherein the Y axis traces being alternatively arranged with the X axis traces so that the X axis sensing units and Y axis sensing units are arranged as a matrix at a working area of a touch panel; and wherein gaps between the X axis traces and Y axis traces are arranged with dummy patterns. The dummy patterns, X axis traces, Y axis traces are arranged on the same plane. Or the dummy patterns and the X axis traces are arranged on the same plane. Or the dummy patterns and the Y axis traces are arranged on the same plane. Or dummy patterns and the X axis traces and/or the Y axis traces are arranged on different planes. The dummy patterns, the X axis traces and the Y axis traces are retained with predetermined gaps without connecting to one another. Preferably the gap is about 50 μm. The X axis traces and Y axis traces are made of same transparent conductive thin film. Preferably, the dummy patterns, X axis traces and Y axis traces are made of same material, such as ITO or PEDOT.

The present invention further provides a capacitive sensing assembly of a touch panel comprising: a lower substrate; an upper panel;

a capacitive sensing layer installed connected the adhering layer and the upper panel; an adhering layer for connecting the adhering layer and the upper panel as one body; wherein in a working area of a touch panel, the capacitive sensing layer having a plurality of sensing units which are arranged alternatively and gaps between the sensing units are filled with dummy patterns; the dummy patterns are insulated to the sensing units and have same or approximately equal transmittance with the sensing units. Each sensing unit may have a triangular shape.

The various objects and advantages of the present invention will be more readily understood from the following detailed description when read in conjunction with the appended drawing.

### BRIEF DESCRIPTION OF THE DRAWINGS

FIG. 1 is a plane view of the adhering layer of the first embodiment of the present invention.

FIG. 2 is an enlarged schematic view of the A part in FIG. 1.

FIG. 3 is a lateral cross sectional view showing the structure of the first embodiment.

FIG. 4 is a plane view about the adhering layer in the first embodiment of the present invention.

FIG. 5 is a cross sectional view showing the structure along line C-C of FIG. 4.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

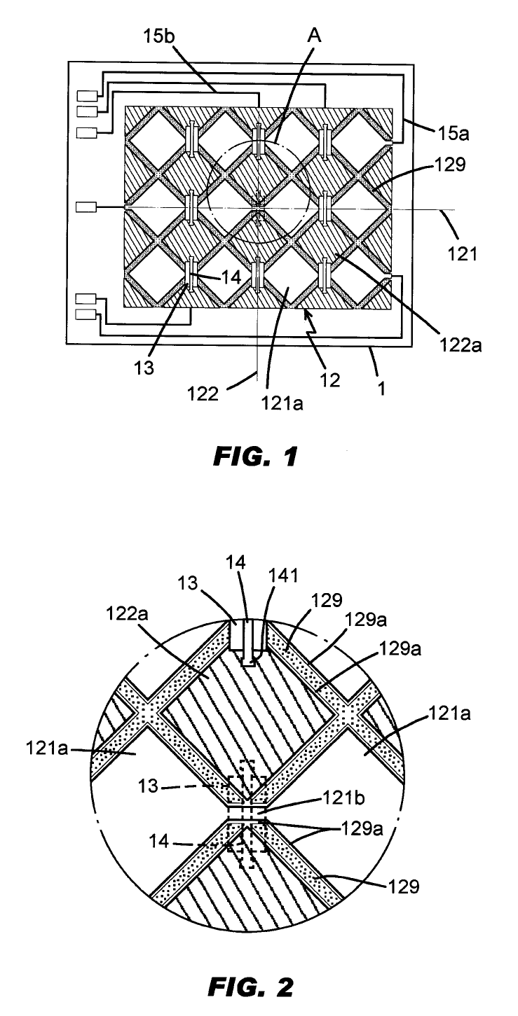

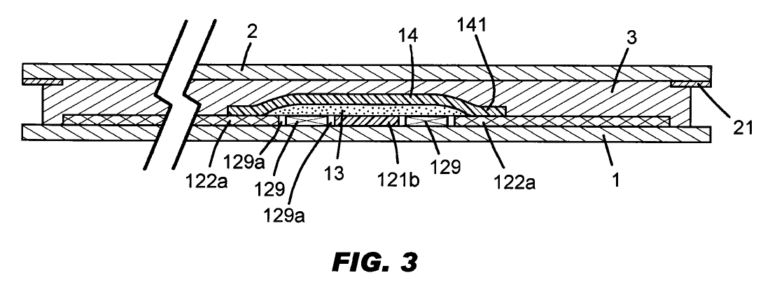

Referring to FIGS. 1 to 3, the preferred embodiment of the present invention is illustrated. The touch panel capacitive sensing assembly of the present invention includes a lower substrate 1 and an upper panel 2 which are combined by an adhering layer 3. A capacitive sensing layer 12 is adhered to the lower substrate 1 or the upper panel 2. The lower substrate 1 and upper panel 2 are made of high light transmission insulating thin glass plate. The adhering layer 3 is transparent UV glue. A periphery of the upper panel 2 is installed with colored mask 21 formed by metal sputtering for shielding metal conductive lines 15a, 15b at the edges of the lower substrate 1. An upper surface of the lower substrate 1 is installed with a capacitive sensing layer 12, an isolating layer 13 and a jump conductive layer 14. The capacitive sensing layer 12 is an ITO transparent conductive thin film. The capacitive sensing layer 12 includes a plurality of X axis traces 121 which are spaced equally and arranged in parallel along X axis and a plurality of Y axis traces 122 which are spaced equally and arranged in parallel along Y axis. The X axis trace 121 and Y axis trace 122 are intersected as a metric. The X axis sensing units 121a of the X axis trace 121 are connected one another and Y axis sensing units 122a of the Y axis trace 122 are isolated one another. Each of one end of the X axis trace 121 and Y axis trace 122 is electrically connected to the metal conductive lines 15a, 15b at the edge of the lower substrate 1 and is connected to a signal output terminal (not shown). Thereby, the sensing signals from the X axis trace 121 and Y axis trace 122 of the capacitive sensing layer 12 are transferred to a proceeding signal processing circuit through the signal output terminal. The isolating layer 13 has a plurality of insulating shielding surfaces which are formed by polyester thin film material of high light transmission with an dielectric coefficient of 3 and a thickness of 1.5 μm. The shielding surfaces are sufficient to cover a part 121b of X axis trace 121 jumping through two adjacent Y axis sensing unit 122a. The jump conductive layer 14 is installed with a plurality of electric conductive wires arranged along Y axis. The electric conductive wire is made of metal conductive material with a wire diameter smaller than 15 μm. Each of two ends of each electric conducive line is formed with an enlarged electric connection portion 141. The electric conducive line is installed at an upper surface of the insulating surface of the isolating layer 13 and the enlarged electric connection portions 141 at two ends of the electric conducive line are exposed out of the insulating surface. Thus, when the capacitive sensing layer 12, isolating layer 13 and the jump conductive layer 14 are assembled, the shielding surface of the isolating layer 13 is installed between the two adjacent Y axis sensing units 122a of the Y axis trace 122 to cover the a part 121b of X axis trace 121 jumping through two adjacent Y axis sensing unit 122a. The enlarged electric connection portions 141 at two ends of the electric conducive line are electrically connected to the two adjacent Y axis sensing units 122a of the Y axis trace 122 so that the Y axis sensing units 122a of one Y axis trace 122 are electrically connected. Thus a capacitive sensing structure is formed. Besides, dummy patterns 129a are installed at the gaps of the X axis sensing units 121a and the Y axis sensing units 122a and do not contact the X axis sensing units 121a and the Y axis sensing units 122a with gaps about 20 μm˜50 μm being formed therebetween. Ideally, the material of the dummy patterns 129a is identical to that of the X axis sensing units 121a and the Y axis sensing units 122a, namely ITO transparent conductive thin film so that that the capacitive sensing layer 12 has uniform light transmission ratio.

From above mentioned structure, an equivalent circuit is formed between the X axis trace 121 and the metal conductive line 15a and an equivalent circuit is formed between the Y axis trace 122 and the metal conductive line 15b. When a finger or a conductor touches or slides through a surface of the touch panel, the signal processing circuit will determine the touch position by the variation of the capacitance. Furthermore, the touch panel of the present invention is a highly transparent panel. Therefore, it can be arranged in front of a screen of an electronic device so that the user can touch a desired position on the screen for operation.

In above capacitor sensing structure, the X axis trace 121 and Y axis trace 122 are arranged at the same surface, namely, at the same capacitive sensing layer 12. Thus, each of the X axis trace 121 and Y axis trace 122 can be arranged precisely without errors. By the dummy patterns 129, the hollow space in the capacitive sensing layer 12 is reduced greatly so as to promote the flatness of the outlook and the light transmission uniformity of the touch panel to improve the defect of distortion. By the installation of the dummy pattern 129, under the condition of without increasing the hollow space of the capacitive sensing layer 12, the gaps between the X axis sensing units 121a and the Y axis sensing units 122a are increased so as to reduce noise levels, Moreover, as illustrated above, the dummy patterns 129, X axis sensing units 121a and Y axis sensing units 122a are made of same material and are formed at the same plane of the capacitive sensing layer 12, and thus, by itching the capacitive sensing layer 12, the structure can be formed one time without extra works or costs.

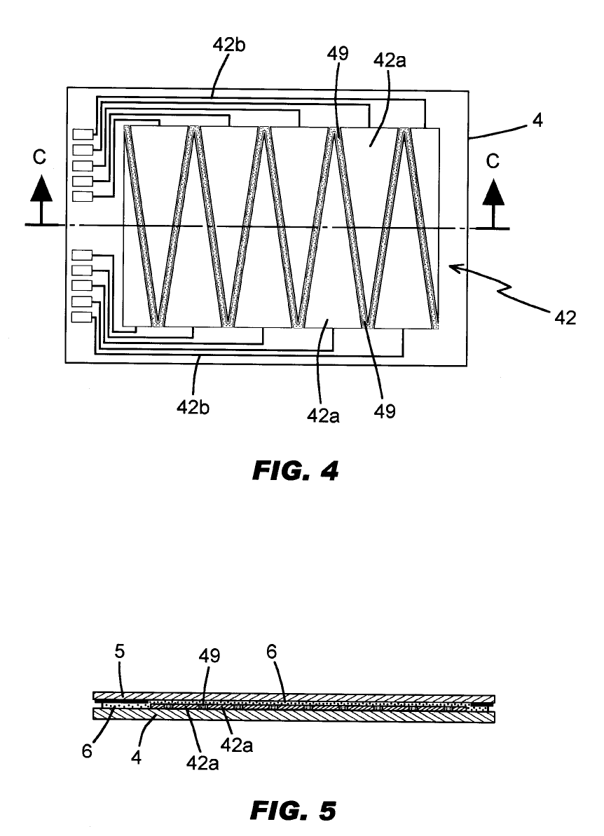

Referring to FIGS. 4 and 5, the second embodiment of the present invention is illustrated. The capacitor sensing structure of the touch panel is identical to that in the first embodiment, namely including a lower substrate 4 and an upper panel 5. A capacitive sensing layer 42 is installed therebetween. An adhering layer 6 is used to combing the lower substrate 4 and the upper panel 5. The difference from the first embodiment is that the installation of the capacitive sensing layer 42. The capacitive sensing layer 42 is installed upon the upper surface of the adhering layer 4. The capacitive sensing layer 42 is made of ITO transparent conductive thin film. The capacitive sensing layer 42 includes a plurality of triangular sensing units 42a. The sensing units 42a are spaced equally and are arranged alternatively (as shown in FIG. 4). Then one end of each sensing unit 42a is electrically connected to a metal conductive line 42b at an edge of the adhering layer 4 and is connected to a signal output terminal (not shown). Thereby, the sensing signal from each sensing unit 42a is transferred to a proceeding signal processing circuit through the signal output terminal. Besides, dummy patterns 49 are filled between the sensing unit 42a and are retained with a predetermined distance with the two adjacent sensing units 42a without connecting thereto. Generally, the gap 49a is between 20 μm˜50 μm. Ideally, the material of the dummy patterns 129 is identical to that of the sensing units 42a, namely, ITO transparent conductive thin film so that the capacitive sensing layer 42 has uniform light transmittance so as to promote the overall flatness of the outlook of the touch panel and the uniformity of the transmittance of the touch panel without the defect of distortion.

However other than above-mentioned features, other variations are still within the scope of the present invention, for example, the X axis traces and Y axis sensing units are installed at two different capacitive sensing layers and an insulation layer serves to separate the two capacitive sensing layers so that the dummy patterns are selectively arranged at the periphery of the X axis traces or Y axis traces. Or for example, the dummy patterns are arranged on the gaps of the insulating layer corresponding to the gaps of the X axis sensing units and Y axis sensing units. All these variations are within the scope of the present invention.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A capacitive sensing assembly of a touch panel comprising:
a plurality of transparent X axis traces; each X axis trace having a plurality of connected X axis sensing units;
a plurality of transparent Y axis traces; each Y axis trace having a plurality of connected Y axis sensing units;
wherein the Y axis traces being alternatively arranged with the X axis traces so that the X axis sensing units and Y axis sensing units are arranged as a matrix at a working area of a touch panel; and
wherein gaps between the X axis traces and Y axis traces are arranged with dummy patterns.

2. The capacitive sensing assembly of a touch panel as claimed in claim 1, wherein the dummy patterns, X axis traces, Y axis traces are arranged on the same plane.

3. The capacitive sensing assembly of a touch panel as claimed in claim 1, wherein the dummy patterns and the X axis traces are arranged on the same plane.

4. The capacitive sensing assembly of a touch panel as claimed in claim 1, wherein the dummy patterns and the Y axis traces are arranged on the same plane.

5. The capacitive sensing assembly of a touch panel as claimed in claim 1, wherein dummy patterns and the X axis traces and/or the Y axis traces are arranged on different planes.

6. The capacitive sensing assembly of a touch panel as claimed in claim 1, wherein the dummy patterns, the X axis traces and the Y axis traces are retained with predetermined gaps without connecting to one another.

7. The capacitive sensing assembly of a touch panel as claimed in claim 6, wherein the gap is about 50 μm.

8. The capacitive sensing assembly of a touch panel as claimed in claim 1, wherein the X axis traces and Y axis traces are made of same transparent conductive thin film.

9. A capacitive sensing assembly of a touch panel comprising:
a lower substrate;
an upper panel;
a capacitive sensing layer installed connected the adhering layer and the upper panel;
an adhering layer for connecting the adhering layer and the upper panel as one body;
wherein in a working area of a touch panel, the capacitive sensing layer having a plurality of sensing units which are arranged alternatively and gaps between the sensing units are filled with dummy patterns; the dummy patterns are insulated to the sensing units and have same or approximately equal transmittance with the sensing units.

10. The capacitive sensing assembly of a touch panel as claimed in claim 1, wherein each sensing unit has a triangular shape.
